(19) United States
(12) Patent Application Publication
(10) Pub. No.: US 2006/0022001 A1
(43) Pub. Date: Feb. 2, 2006

(54) Aerial boom attachment

(75) Inventors: Eric R. Linsmeier, Larsen, WI (US); David W. Archer, Hortonville, WI (US)

Correspondence Address: FOLEY & LARDNER LLP, 777 EAST WISCONSIN AVENUE, SUITE 3800, MILWAUKEE, WI, 53202-5308, US

(73) Assignee: Oshkosh Truck Corporation

(21) Appl. No.: 10/902,500

(22) Filed: Jul. 29, 2004

(51) Int. Cl. B60P 3/22

(52) U.S. Cl. 222/608

(57) ABSTRACT

An aerial boom attachment for use with an aerial boom mounted on a vehicle. The aerial boom attachment includes a frame assembly configured to couple to the aerial boom. A drive train assembly is mounted on the frame assembly. The drive train assembly includes two opposing actuators, wherein when one actuator moves in one direction, the other actuator moves in an appropriate opposite direction. A piercing nozzle assembly is coupled to the drive train and configured for motion in one of a vertical and horizontal plane, with the piercing nozzle assembly in fluid communication with a fluid supply. The piercing nozzle assembly can operate within a predetermined range of positions relative to the center line of the frame assembly

### BACKGROUND OF THE INVENTION

The present invention relates to vehicle aerial lifts in general and in particular to an aerial boom attachment for use with an aerial boom mounted on a vehicle, with the attachment including a piercing nozzle assembly.

Prior art vehicles, specifically fire-fighting types of vehicles, such as fire trucks and crash rescue trucks have a variety of equipment and apparatus utilized during fire-fighting and rescue operations. Such vehicles typically utilize fluid dispensing devices such as aerial lifts and fluid nozzles on an outer end of a boom mechanism. The booms can be mounted on the top side of the vehicle, about its midsection, with the booms capable of articulating or telescoping to various position as directed by the operator. The piercing nozzle is used to penetrate a structure, such as an aircraft fuselage, from a remote distance and enable a fire retardant to be injected into the interior of the structure.

In the typical penetrating nozzle assembly, the penetrating nozzle must be in substantial axial alignment with the boom to maximize the force exerted by the piercing nozzle. With the piercing nozzle in substantial axial alignment with the boom, a minimal vertical force will be exerted on the piercing nozzle. Existing piercing nozzle apparatus typically include a slip clutch mounted between the outer end of the boom and the drive means to limit the forces on the piercing nozzle if the piercing nozzle is not axially aligned with the boom during the penetration procedure. A slip clutch typically causes the piercing nozzle to disconnect from the drive means to avoid damage to the nozzle assembly. Such disconnect, requires an operator of such piercing nozzle apparatus to retract the nozzle from the structure, recouple the piercing nozzle apparatus to the drive means and again attempt the piercing procedure with a better aligned piecing nozzle. Such action takes time and exposes an operator to the dangers in fighting the fire or attempting a rescue.

Thus, there is a need for an aerial boom attachment having a piercing nozzle assembly that includes an overload relief apparatus configured to limit a vertical force on a piercing nozzle assembly if the piercing nozzle is not in axial alignment with the boom. There is a further need for an aerial boom attachment having a piercing nozzle assembly that does not require the operator to manually recouple the piercing nozzle assembly to a drive apparatus. There is also a need for a piercing nozzle assembly that will not require recalibration after an overload protection operation.

### SUMMARY OF THE INVENTION

There is provided a fluid delivery system for delivering fluid from a fluid supply into an enclosure. The fluid delivery system includes an elongated aerial boom configured to be raised and lowered by a vehicle. A piercing nozzle is configured to pierce the enclosure. At least two actuators are coupled to each other to move simultaneously coupled to the boom, and coupled to the piercing nozzle to move the piercing nozzle to move simultaneously. The piercing nozzle can operate within a predetermined range of positions, relative to the center line of the aerial boom. Another embodiment of the fluid delivery system is an overload relief apparatus in communication with the actuators, with the overload apparatus configured to limit a vertical force on the piercing nozzle. Another embodiment includes a turret nozzle coupled to the aerial boom and in fluid communication with the fluid supply. Another embodiment of the fluid delivery system includes an electronic control system coupled to the piercing nozzle, wherein the electronic control system is coupled to a first position sensor associated with the actuators and a second position sensor associated with the piercing nozzle, and receiving a signal from each sensor corresponding to relative positions of the actuators and piercing nozzle indexed to the aerial boom position.

There is further provided a fire truck comprising an aerial boom and an aerial boom attachment. The aerial boom attachment includes a frame assembly configured to couple to the aerial boom. A drive train assembly is mounted on the frame assembly. The drive train assembly includes two opposing actuators, wherein when one actuator moves in one direction, the other actuator moves in an appropriate opposite direction. A piercing nozzle assembly is coupled to the drive train and configured for motion in one of a vertical and horizontal plane, with the piercing nozzle assembly in fluid communication with a fluid supply. The piercing nozzle assembly can operate within a predetermined range of positions relative to the center line of the frame assembly. Another embodiment of the fire truck includes an overload relief apparatus in communication with the actuators in the drive train assembly with the overload apparatus configured to limit a vertical force on the piercing nozzle assembly. Another embodiment of the fire truck includes a turret nozzle mounted on the frame assembly and in fluid communication with the fluid supply. Another embodiment includes an electronic control system coupled to the drive train assembly and piercing nozzle assembly, wherein the electronic control system is coupled to a first position sensor associated with the drive train assembly and a second position sensor associated with the piercing nozzle assembly. The electronic control system receives a signal from each sensor corresponding to relative positions of the drive train assembly and the piercing nozzle assembly indexed to the boom position.

There is also provided a fire truck including a first boom coupled to the fire truck and configured to pivot relative to the fire truck. A second boom is coupled to the first boom and configured to pivot relative to the first boom. A plurality of hydraulic cylinders are coupled to each of the first and second booms to raise and lower each boom. A conduit is coupled to each boom and configured to convey fluid. A fluid delivery system for delivering fluid includes a piercing nozzle and at least two actuators coupled to each other to move simultaneously coupled to the second boom, and coupled to the piercing nozzle to move the piercing nozzle while moving simultaneously, wherein the conduit and piercing nozzle is coupled to a fluid pump. Another embodiment of the fire truck includes an all wheel steering system.

### BRIEF DESCRIPTION OF THE DRAWINGS

FIG. 1 is an illustration of a fire-fighting vehicle having an aerial boom and an exemplary embodiment of an aerial boom attachment poised to pierce a structure, with the piercing nozzle not in axial alignment with the aerial boom.

FIG. 2 is a perspective view of an exemplary embodiment of an aerial boom assembly, including a piercing nozzle assembly coupled to a drive train assembly and a turret nozzle.

FIG. 3 is a side plan view of the aerial boom assembly illustrated in FIG. 2, illustrating one position of opposing actuators coupled to a drive wheel of the drive train assembly.

FIG. 4 is a partial perspective view of the aerial boom attachment illustrated in FIG. 3.

FIG. 5 is a perspective view of an exemplary embodiment of an aerial boom attachment without a turret nozzle.

FIG. 6 is a perspective view of a piercing tool according to an exemplary embodiment.

FIG. 7 is a side view of the piercing tool illustrated in FIG. 6 according to an exemplary embodiment.

### DETAILED DESCRIPTION OF THE EXEMPLARY EMBODIMENTS

Before discussing exemplary embodiments of aerial boom attachments for the vehicle 2, there are a few preliminary comments. When referring to a vehicle 2, it is contemplated that a vehicle 2 can be of several different uses and can be referred to as a work vehicle 2, a fire-fighting vehicle 2, a crash truck or airport rescue and fire-fighting vehicle (ARFF) 2, a multi-wheel vehicle 2 or the like. It is also contemplated that articulated tracks mounted on the wheels 12 can be used as a support for the support structure 4 of the vehicle 2. The vehicle 2 also typically has an area designated as a vehicle front 6, vehicle side 8 and includes a vehicle body 10. It is contemplated that any convenient and conventional materials can be utilized for such vehicle portions commensurate with the type of duty that will be experienced by such vehicle. For example, the body can be made out of steel, aluminum, composite materials or a combination of such materials. The wheels 12 can be cast or machined, etc. At least one wheel set can be steerable and at least two wheels are coupled to a drive motor. The drive motor may include a turbine engine, an electronic motor, an internal combustion engine, a hybrid-electric system or any combination of such devices.

A fluid source 14 can be mounted directly on a vehicle 2, can be towed on a separate trailer structure (not shown), or can be a fixed fluid source 14 such as a lake, river or tank. For example, if the vehicle 2 is configured as a fire-fighting vehicle, the fluid source 14 is typically mounted on the vehicle 2, or the vehicle can be brought to an independent fluid source 14 which then utilizes the vehicle 2 for pumping purposes. The fluid source 14 can be a fluid, for example, water, or a chemical, for example foam. A pump 16 is coupled to a conduit 26 which is configured to convey the fluid to the aerial boom attachment 30. The conduit 26 is coupled to each boom 152, 163. The pump 16 can be powered by the vehicle drive power source or by a separate power source, for example an internal combustion engine.

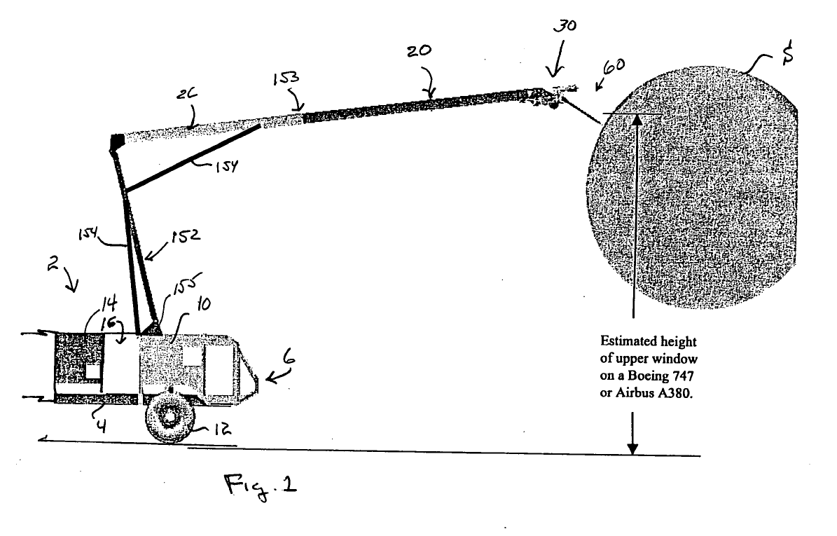

FIG. 1 illustrates a fire/crash rescue vehicle 2 including an aerial boom 20 extended towards the structure S for example, an aircraft fuselage. Attached to the aerial boom 20 is an exemplary embodiment of an aerial boom attachment 30 having a piercing nozzle assembly 60. In a typical operation, the piercing nozzle assembly 60 will be positioned next to the structure S and pushed into the structure S by the aerial boom 20. A fire retardant material is then injected into the structure.

Prior art piercing nozzle assemblies have to be axially aligned with the center line of the boom in order to maximize the force needed to penetrate the structure. If the piercing nozzle is not properly aligned, the nozzle will not penetrate the structure and the nozzle can be damages. Proper alignment typically means the piercing nozzle is at a right angle to the structure. A slip-clutch has been used to decouple the piercing nozzle to minimize damage to the nozzle if it is not properly aligned. However, the then freely swinging nozzle cannot be used until the operator recouples the nozzle to the mechanism and recalibrates its position relative to the aerial boom. The operator typically has to go outside of the cab of the fire truck in order to recouple the nozzle. An approach angle other than 90° will typically cause the piercing nozzle to slip and not penetrate the structure.

Aerial boom 20 comprises a first boom pivotally coupled to vehicle 2 by way of mounting assembly 155. Member 152 is coupled to a second boom 153. A piercing nozzle assembly 60 which is configured to couple to piercing tool 70 is coupled to the second boom 153. According to various exemplary embodiments, the first and second booms 152, 153 may be fixed in length or alternatively may be adjustable in length. Further, booms 152, 153 may comprise a telescopic configuration for extending and retracting in length. Furthermore, member 152 may comprise one or more joints for pivotal movement. According to an exemplary embodiment, aerial boom 20 may comprise any number of members coupled together and/or to other objects according to any suitable arrangement. The aerial boom may be composed of any suitable material having characteristics sufficient for the application. For example, the booms 152, 153 can be composed of metal or a composite material, or a combination of both. The boom sections 152, 153 are raised and lowered by a plurality of hydraulic cylinder 154 coupled to each of the first boom 152 and second boom 153. The hydraulic cylinders 154 are coupled to suitable and appropriate hydraulic control valves.

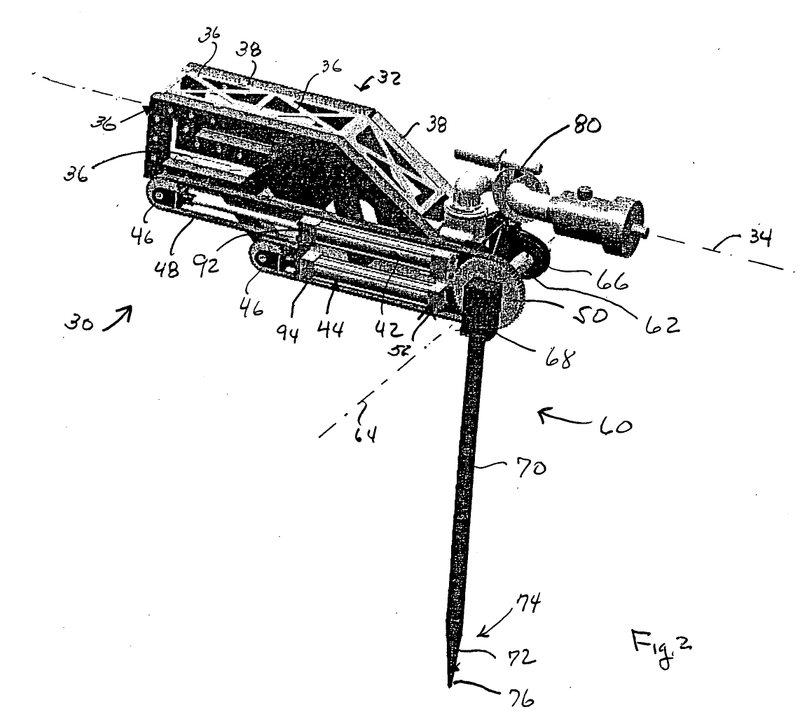

FIGS. 2-5 illustrate exemplary embodiments of an aerial boom attachment 30. The aerial boom attachment 30 includes a frame assembly 32, a drive train assembly 40 and a piercing nozzle assembly 60.

The frame assembly 32 couples to the aerial boom 20. The frame assembly 32 can be coupled to the boom 20 by any convenient and suitable manner, for example, nuts and bolts, bands or straps, etc. The frame assembly 32 is composed of frame members 38 forming a lattice-type framework. The frame members 38 can be of any suitable geometric cross section, for example, angle beams, tubes, etc. and composed of any suitable material, such as steel, aluminum, composite material or a combination of such materials. The frame assembly 32 can be fabricated by individual parts conveniently fastened together with, for example, screws, bolts or welded or adhesives or it can be molded as a single piece. Several removable frame sections 36 are coupled to the frame members 38 for added stability. The removable frame sections 36 can be removed to provide access to components of the aerial boom attachment 30, such as couplings, electrical connections and for maintenance work, etc. The center line of the frame assembly 34 is axially aligned with the boom 20.

The frame assembly 32 supports the drive train assembly 40 which is mounted on the frame assembly 32. The drive train assembly 40 is axially aligned with the center line of the frame assembly 34 and parallel to the center line.

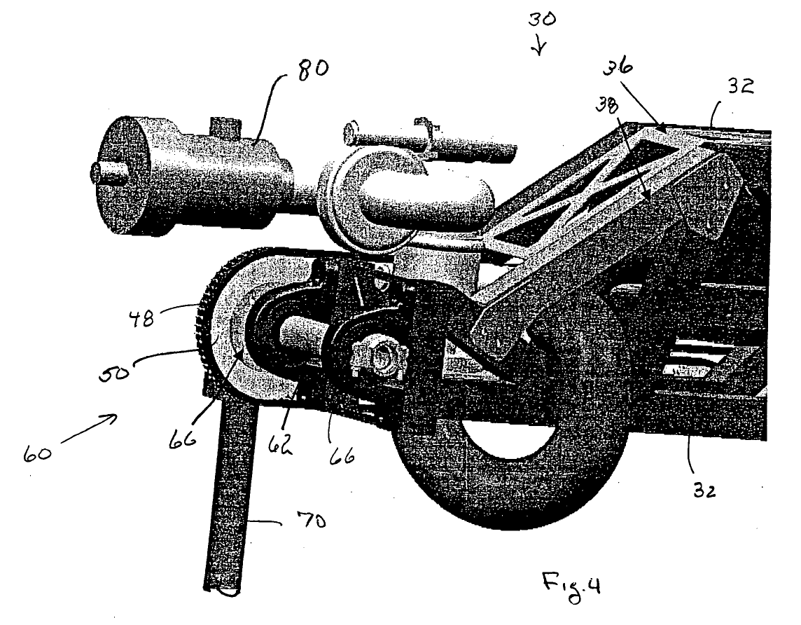

The drive train assembly includes a drive wheel 50 mounted on a rotational shaft 32. The rotational shaft 32 is coupled to the frame assembly 32 with bearings 66, such as pillow block bearings (see FIG. 4). The rotational shaft 32 is mounted on an axis 64 traverse to the center line of the frame assembly 34. The rotational shaft 62 can be a hollow tube and can be coupled to the fluid supply 14 to route the fire retardant fluid.

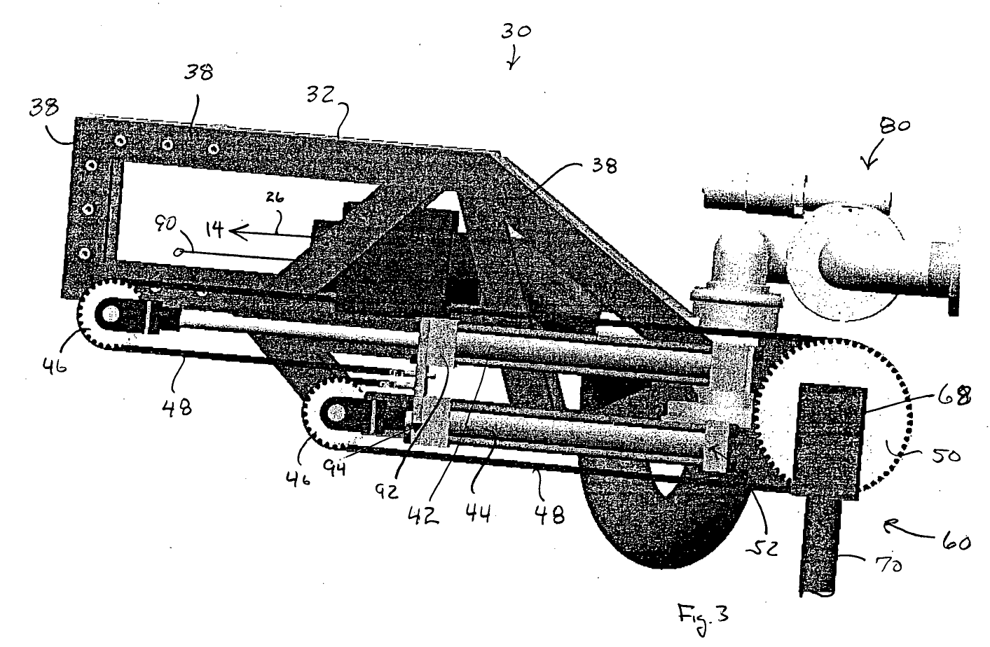

The drive train assembly 34 includes two opposing actuators, a first actuator 42 and a second actuator 44. The actuators 42, 44 are configured so that one actuator moves in one direction and the other actuator moves in a proportionate opposite direction. The two actuators 42, 44, each have a drive pulley 46, are coupled to the drive wheel 50 by a flexible linkage 48. The flexible linkage 48 can be, for example, a cable, a chain, a belt, etc. It can also be multiple members or a single member. FIGS. 3, 4 and 5 illustrate one exemplary embodiment of such arrangement.

The actuators 42, 44 can be fluid cylinders, for example, two-way hydraulic cylinders. As illustrated in FIGS. 3 and 4, when one cylinder retracts, the other cylinder extends by the same amount. Such movement exerts a force on the flexible linkage 48, which in turn moves the drive wheel 50. The actuators are arranged to allow the bore side of each actuator to be utilized. By using the bore side of the actuator, a higher retaining force can be achieved while keeping the cylinder size to a minimum. Control of the actuators 42, 44 is maintained from the cab of the vehicle 2.

The drive train assembly 40 can include an overload relief apparatus 52 integrated in each actuator 42, 44. The overload relief apparatus 52 can be, for example, a relief valve in the cylinder configured to dump the cylinder fluid to tank if a force on the cylinder exceeds a predetermined level. The overload relief apparatus 52 also functions to limit a vertical force on the piercing nozzle assembly 60 as will be explained below.

The piercing nozzle assembly 60 is coupled to the drive train assembly 40. A manifold 68 is mounted on the drive wheel 50. The piercing nozzle assembly 60 is configured for motion in one of the vertical and horizontal plane. In the vertical plane, the motion is provided by rotation of the drive wheel 50 and in the horizontal plane, the motion is provided by movement of the aerial boom 20. A piercing tube 70 is mounted to the manifold. The piercing tube is hollow and is in fluid communication with the fluid supply 14 through the manifold 68. A piercing nozzle 72 is mounted at the distal end of the piercing tube 70. The piercing nozzle defines a plurality of orifices which allow the fire retardant fluid to pass through. A piercing tip 76 is mounted at the distal end of the piercing nozzle 72 and is configured to allow the tip to penetrate a structure S to minimize or prevent the tip from slipping off at a low pierce angle. The piercing nozzle assembly 60 can operate within a predetermined range of positions relative to the center line of the frame assembly 34 and is configured to penetrate a structure S even if the piercing nozzle assembly 60 is not in axial alignment with the center line of the frame assembly 34.

As discussed above, the drive train assembly 40 with the opposing actuators 42, 44 and the overload relief apparatus 52 integral with the drive train assembly allow the penetrating nozzle assembly to operate at angles other than 90° to the structure to be penetrated. Once the piercing tip 76 is positioned, as the aerial boom 20 pushes the piercing tube 70 into the structure, the opposing cylinders 42, 44 operate to lock the piercing tip 76 into position. The overload relief apparatus 52 relief valves are calibrated to allow a piercing tip movement until just before the piercing tip fails as determined by the manufacturer of the aerial boom attachment 30.

Another embodiment of the aerial boom attachment 30 includes an electronic control system 90 coupled to the drive train assembly 40 on the piercing nozzle assembly 60. The electronic control system 90 is coupled to a first position sensor 92 associated with the drive train assembly 40 and a second position sensor 94 associated with the piercing nozzle assembly 60. The position sensors 92, 94 generate a signal corresponding to the relative positions of the drive train assembly 40 and the piercing nozzle assembly 60 indexed to the boom position. The sensors can be linear encoders or similar devices mounted in the actuators 42, 44 which allow constant position sensing. In the event that the vertical force exerted on the piercing nozzle assembly exceeds the limits set on the overload relief apparatus 52 the overload relief apparatus will allow the actuator to move as the boom continues to exert a force. The movement of the actuator in turn moves the driver wheel 50 thereby moving the piercing tube 70 to prevent damage. The position sensors 92, 94 allow the operator to know the position of the piercing tube 70 and reset the piercing nozzle assembly 60 from within the cab by manipulating the actuators 42, 44 to again properly align the piercing tube 70 for penetration of a structure S.

Another embodiment of the aerial boom attachment includes a turret nozzle 80 which is mounted on the frame assembly 32 and is in fluid communication with the fluid supply 14. The turret nozzle 80 is configured to rotate 90° to either side of the center line of the frame assembly 34 and 90° in a vertical plane. The turret nozzle 80 can also be configured to rotate 70° above the center line of the frame assembly 34 and 20° below the center line of the frame assembly 34. The turret nozzle 80 has an independent drive mechanism for moving the turret nozzle as directed by an operator and is provided with position sensors which generate a signal informing the operator as to the orientation of the turret nozzle.

The piercing nozzle assembly is capable of rotating 360° in the vertical plane, 180° above the plane of the boom and 180° below the plane of the boom. The piercing nozzle assembly 60 and the turret nozzle 80 can be coupled independently to the fluid supply 14 or they can be coupled through a common conduit through a diverting valve to direct the flowable fire retardant to either the turret nozzle 80 or the piercing nozzle assembly 60.

The piercing tube 70, piercing nozzle 72 and piercing tip 76 can be interchangeable to accommodate various dimensions as determined by an operator. The overload protection apparatus 52 can be adjusted to accommodate the various dimensions of the interchangeable piercing tube, piercing nozzle 72 and piercing tip 76 due to its dimension and material characteristics and to set a maximum allowable force traverse to the axis of the piercing tube without failure of the piercing tube. It should be understood that the drive train assembly 40 moves the piercing nozzle assembly as determined by an operator, however, that the force exerted on the piercing nozzle assembly 60, and particularly the piercing tube 70 through the piercing tip 76 will also move the actuators 42, 44 as the aerial boom 20 pushes the piercing nozzle tip 76 into the structure. The position sensors 92, 94 associated with the actuators 42, 44 provide a signal to the electronic control system 90 thereby allowing the operator to monitor the position of the piercing apparatus and maintain its calibration and index relative to the boom position. Since different piercing tip assemblies are available and interchangeable, the maximum angles at which the piercing tip can penetrate a structure without failure will vary between individual tip designs. Adjusting for such characteristics can be affected through changes in the overload relief apparatus 52 and the type of actuators 42, 44 utilized in the drive train assembly 40.

Piercing nozzle assembly 60 is coupled to the distal end of the second boom 153 of the aerial boom 20 and typically includes an aerial boom attachment 30, a piercing nozzle 72 coupled to aerial boom attachment 30, and a piercing tool 70 coupled to piercing nozzle 72. The aerial boom attachment 30 is configured to control the motion of piercing nozzle assembly 60 in both the horizontal and vertical directions. Aerial boom attachment 30 can be controlled either manually or remotely from vehicle 2 (e.g., using operator station) depending on the particular circumstances in which vehicle 2 is being utilized. Piercing nozzle 72 is typically coupled to a fluid source 14 and is shaped as a frustum with a hollow passage therein and includes a plurality of openings configured to dispense a pressurized fluid or other material from the fluid source. The interchangeable piercing tool 74 is generally configured to penetrate a structure so that piercing nozzle assembly 60 may dispense the pressurized fluid or other material inside the structures.

The fluid source 14 can be mounted directly on vehicle 2, such as a fluid tank or chemical tank. The fluid source may also be an independent fluid source, such as a separate trailer structure, a separate tank vehicle, or a fixed fluid source, such as a lake, river, reservoir, tank, public or municipal utility source (e.g., a hydrant coupled to a pressurized fluid source), etc. The independent fluid source may be coupled to vehicle 2 for pumping purposes.

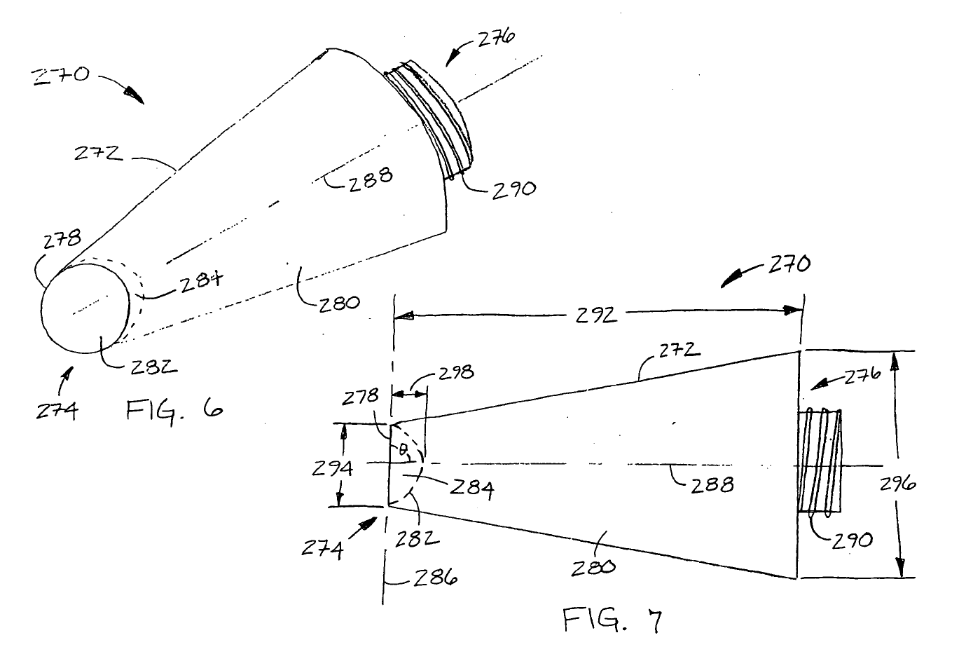

FIGS. 6 and 7 illustrate an exemplary embodiment of a piercing tool 270. Piercing tool 270 includes a member 272 having an end 274 and an end 276. Piercing tool 270 is generally configured to penetrate a wall of a structure, such as a building or an airplane fuselage, so that a flame-retardant fluid or material may be dispensed within the structure by a piercing nozzle assembly during fire-fighting and rescue operations. More specifically, piercing tool 270 is configured to penetrate a structure such as a building or an airplane fuselage from a number of different angles without requiring a significantly high degree of perpendicular alignment with the surface of the structure.

End 274 includes a cutting edge 278 formed by the intersection of a first surface 280 and a second surface 282 and configured to facilitate the penetration of a structure from a number of different angles without requiring a significantly high degree of perpendicular alignment with the surface of the structure. Cutting edge 278 may have a variety of different configurations depending upon the shape of the intersection of the first surface 280 and the second surface 282. For example, in the illustrated embodiment, the intersection of the first surface 280 and the second surface 282 is circular in shape, which provides an annular cutting edge 278. According to other embodiments, cutting edge 278 is configured as other shapes, such as other elliptical shapes, ovular shapes, many-sided shapes, etc. Cutting edge 278 may have also variety of different configurations depending upon the orientation of the intersection of the first surface 280 and the second surface 282. For example, in the illustrated embodiment, surface 280 and surface 282 intersect in a plane 286 according to an angle θ such that plane 286 is substantially perpendicular to a longitudinal axis 288 of member 272. According to other exemplary embodiments, different angles and planes of intersection are used to define cutting edge 278.

First surface 280 is a tapered outer surface of member 272, with the surface tapering toward end 274 such that end 274 is narrower in width or diameter than end 276. Surface 280 may be a number of different shapes. For example, in the illustrated embodiment, Surface 280 has the shape of an elliptical frustum having a circular cross section. Other exemplary shapes of surface 280 include frustums or other tapered extrusions having ovular, egg-shaped, or many-sided cross sections, etc.

Second surface 282 defines a cavity 284 within member 272. Second surface 282 and cavity 284 may be a number of different shapes. For example, in the illustrated embodiment, surface 282 is a concave surface such that cavity 284 is shaped as a section of a sphere. Other exemplary configurations of surface 282 and cavity 284 include frustums, conics, cylinders, etc.

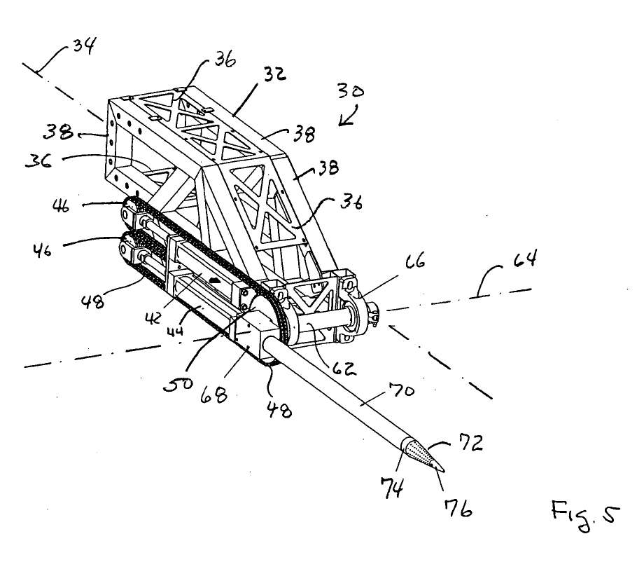

End 276 is configured to facilitate the coupling of piercing tool 270 to piercing nozzle assembly 60 shown in FIGS. 2 and 5. Any common means of attachment, such as welding, brazing, interlocking configurations, etc., may by used to couple piercing tool 270 to piercing nozzle assembly 60. For example, in the illustrated embodiment, end 276 includes screw-type mating threads 290 for removably coupling piercing tool 270 to piercing nozzle assembly 60 so that piercing tool 270 may be replaced if, for example, it breaks or becomes dull.

Piercing tool 270 may be formed from various different materials. According to an exemplary embodiment, piercing tool 270 is formed from a durable rigid material. For example, piercing tool 270 may be made from metal, alloys, steel, composites, etc. In addition, according to various other embodiments, piercing tool 270 is optionally coated or plated with a material such as chrome, or heat treated or plated with a hardened coating such as tungsten carbide.

Piercing tool 270 may have varying overall size and dimensions based on, for example, the particular piercing application, the thickness and material of the structure to be pierced, the strength of the components to which piercing tool 270 is attached, etc. For example, according to an exemplary embodiment, piercing device 270 is configured to penetrate an aluminum aircraft fuselage and has a length 292 of approximately four inches, a width or diameter 294 of end 274 of approximately three quarters of an inch, a width or diameter 296 of end 276 of approximately one quarter of an inch, and a depth 298 of cavity 284 of approximately one eighth of an inch. According to other exemplary embodiments, these dimensions are varied as applicable.

It is also contemplated that additional tools and apparatus can be mounted on the aerial boom attachment 30 that is appropriate for a given application such as for instance, a video camera, for example, an infrared video camera, a spot or search light, a hose and reel assembly, hydraulic actuated jaws for manipulating metal or such other appropriate tool for use with an aerial boom attachment 30. Additional modifications will be evident to those with ordinary skill in the art.

Thus, there is provided an aerial boom attachment for use with an aerial boom on a vehicle. While the embodiments illustrated in the figures and described above are presently preferred, it should be understood that these embodiments are offered by way of example only. The invention is not intended to be limited to any particular embodiment but is intended to extend to various modifications that nevertheless fall within the scope of the appended claims.

What is claimed is:

1. A fluid delivery system for delivering fluid from a fluid supply into an enclosure comprising:
an elongated aerial boom configured to be raised and lowered by a vehicle;
a piercing nozzle configured to pierce the enclosure; and
at least two actuators coupled to each other to move simultaneously, coupled to the boom, and coupled to the piercing nozzle to move the piercing nozzle while moving simultaneously.

2. The fluid delivery system of claim 1, wherein the piercing nozzle can operate within a predetermined range of positions.

3. The fluid delivery system of claim 2, wherein the range of positions is not in axial alignment with the aerial boom.

4. The fluid delivery system of claim 1, including an overload relief apparatus in communication with the actuators, with the overload apparatus configured to limit a vertical force on the piercing nozzle.

5. The fluid delivery system of claim 1, including a turret nozzle mounted on the aerial boom and in fluid communication with the fluid supply.

6. The fluid delivery system of claim 5, wherein the turret nozzle is configured to rotate 90° to either side of the centerline of the aerial boom and 90° in a vertical plane.

7. The fluid delivery system of claim 5, wherein the turret nozzle is configured to rotate 70° above the centerline of the aerial boom and 20° below the centerline of the aerial boom.

8. The fluid delivery system of claim 1, including an electronic control system coupled to the piercing nozzle, wherein the electronic control system is coupled to a first position sensor associated with the actuators and a second position sensor associated with the piercing nozzle, and receives a signal from each sensor corresponding to relative positions of the actuators and piercing nozzle indexed to the aerial boom position.

9. The fluid delivery system of claim 1, wherein the piercing nozzle includes an interchangeable piercing tool.

10. The fluid delivery system of claim 1, wherein the piercing nozzle is configured to provide 360° of rotation about an axis traverse to the longitudinal centerline of the aerial boom.

11. A fire truck comprising:
an aerial boom; and
an aerial boom attachment comprising:
a frame assembly configured to couple to the aerial boom;
a drive train assembly mounted on the frame assembly, the drive train assembly including two opposing actuators, wherein when one actuator moves in one direction, the other actuator moves in a proportionate opposite direction; and
a piercing nozzle assembly coupled to the drive train and configured for motion in one of a vertical and horizontal plane, with the piercing nozzle assembly in fluid communication with a fluid supply, wherein the piercing nozzle assembly can operate within a predetermined range of positions relative to the centerline of the frame assembly.

12. The fire truck of claim 10, wherein the range of positions is not in axial alignment with the centerline of the frame assembly.

13. The fire truck of claim 10, including an overload relief apparatus in communication with the actuators, with the overload apparatus configured to limit a vertical force on the piercing nozzle assembly.

14. The fire truck of claim 10, including a turret nozzle mounted on the frame assembly and in fluid communication with the fluid supply.

15. The fire truck of claim 14, wherein the fluid supply is on-board the fire truck.

16. The fire truck of claim 15, wherein the turret nozzle is configured to rotate 90° to either side of the centerline of the frame assembly and 90° in a vertical plane.

17. The fire truck of claim 16, wherein the turret nozzle is configured to rotate 70° above the centerline of the frame assembly and 20° below the centerline of the frame assembly.

18. The fire truck of claim 11, including an electronic control system coupled to the drive train assembly and piercing nozzle assembly, wherein the electronic control system is coupled to a first position sensor associated with the drive train assembly and a second position sensor associated with the piercing nozzle assembly, and receives a signal from each sensor corresponding to relative positions of the drive train assembly and piercing nozzle assembly indexed to the boom position.

19. The fire truck of claim 11, wherein the piercing nozzle assembly includes an interchangeable piercing tool.

20. The fire truck of claim 11, wherein the piercing nozzle assembly is configured to provide 360° of rotation about an axis traverse to the longitudinal centerline of the frame assembly.

21. A fire truck comprising:
a first boom coupled to the fire truck and configured pivot relative to the fire truck;
a second boom coupled to the first boom and configured to pivot relative to the first boom;
a plurality of hydraulic cylinders coupled to each of the first and second boom to raise and lower each boom;
a conduit coupled to the each boom and configured to convey fluid; and
a fluid delivery system for delivering fluid, comprising:
a piercing nozzle; and
at least two actuators coupled to each other to move simultaneously, coupled to the second boom, and coupled to the piercing nozzle to move the piercing nozzle while moving simultaneously,
wherein the conduit and piercing nozzle are coupled to a fluid pump.

22. The fire truck of claim 21, including an all-wheel drive system.

23. The fire truck of claim 22, including an all-wheel steering system.

24. The fire truck of claim 21, including an all-wheel steering system.

25. The fire truck of claim 21, wherein the piercing nozzle can operate within a predetermined range of positions.

26. The fire truck of claim 25, wherein the range of positions is not in axial alignment with the second boom.

27. The fire truck of claim 21, including an overload relief apparatus in communication with the actuators, with the overload apparatus configured to limit a vertical force on the piercing nozzle.

28. The fire truck of claim 21, including a turret nozzle mounted on the second boom and in fluid communication with the fluid pump.

29. The fire truck of claim 28, wherein the turret nozzle is configured to rotate 90° to either side of the centerline of the second boom and 90° in a vertical plane.

30. The fire truck of claim 28, wherein the turret nozzle is configured to rotate 70° above the centerline of the second boom and 20° below the centerline of the second boom.

31. The fire truck of claim 21, including an electronic control system coupled to the piercing nozzle, wherein the electronic control system is coupled to a first position sensor associated with the actuators and a second position sensor associated with the piercing nozzle, and receives a signal from each sensor corresponding to relative positions of the actuators and piercing nozzle indexed to the position of the second boom.

32. The fire truck of claim 21, wherein the piercing nozzle includes an interchangeable piercing tool.

33. The fire truck of claim 21, wherein the piercing nozzle is configured to provide 360° of rotation about an axis traverse to the longitudinal centerline of the second boom.

34. The fire truck of claim 21, wherein one of the first boom and second boom is configured to move telescopically.
